(19) United States
(12) Patent Application Publication
(10) Pub. No.: US 2011/0304943 A1
(43) Pub. Date: Dec. 15, 2011

(54) RELOCATABLE SURGE SUPPRESSION OR SURGE PROTECTION DEVICE

(76) Inventors: Bruce Barton, Huntington, NY (US); Russell Barton, Northport, NY (US)

(21) Appl. No.: 12/813,234

(22) Filed: Jun. 10, 2010

(51) Int. Cl. H02H 5/04

(52) U.S. Cl. 361/104

(57) ABSTRACT

A surge suppression or surge protection device for affording enhanced safety by disconnecting a protected device should a fault occur, and which is preferably formed as part of an electrical power strip, preferably includes a plurality of fuses with at least one fuse being a thermal fuse and a heating element in proximity to the thermal fuse for opening the thermal fuse, when heated. The heating element may preferably be a positive coefficient self-regulating heating element.

### BACKGROUND OF THE INVENTION

1. Technical Field of the Invention

The present invention relates, generally, to a relocatable surge suppression or surge protection device for the distribution of electrical power, which provides increased safety, as compared to similar electrical devices currently known to the prior art.

More particularly, the present invention relates a relocatable surge protection or surge suppression for the protection of equipment using electrical power, preferably formed as part of an electrical power strip, having improved safety for minimizing, if not outright preventing, an electrical fire or similar occurrence that may otherwise result from multiple surge events.

2. Description of the Prior Art

Presently, for surge protection power strips to meet established safety standards, fuses are placed in series with the metal oxide varistors (“MOVs”) and are not in series with the protected load. When the fuses open, the “protected load” is now unprotected. Simply placing fuses in series with the neutral leg to the protected devices would not pass the current safety requirements.

Lee, U.S. Pat. No. 7,428,133, issued Sep. 23, 2008, discloses a protection device for a surge protector, which can automatically cut off the power by using a switching circuit to drive a resistor being heated when the surge protector fails, so as to achieve the goal of automatically cut off the power source. Lee provides that the resistor is connected to the output of the fuse to prevent burning after the fuse has blown.

Lee uses a resistor as the heating element, which is problematic because resistors are simply not designed for this purpose. The resistor, for example, could open before the fuse opens, thereby leaving the surge protection device unprotected. In order to have a resistor heat quickly, it must be driven close to, or even above, the point of failure. At such levels, the resistor itself could burn, therefore requiring that it be connected to the output of the fuse to turn “off” the resistor after the thermal fuse has opened.

By contrast, a heating element can heat up much more quickly, and to higher temperatures, than a resistor without the hazard of burning. Heating elements, such as positive temperature coefficient (PTC) heat elements, are self-regulating. A PTC thermistor will rapidly heat to an intended temperature and substantially remain at the intended, or set, temperature without burning. Another example of a PTC heater is a light bulb filament, which when cold it has a low resistance, and a much higher resistance when hot. The use of a heating wire allows for wrapping around the fuse.

Lee provides a circuit diagram (FIG. 1), in which the switching circuit lacks means for sensing when the thermal fuse (TF1) has opened, but, instead, disconnects the heating resistor (R1) by removing the source power when the thermal fuse (TF1) has opened. Having a switching circuit, with the output of the thermal fuse (TF1) connected thereto, would allow the heating resistor (R1) be connected to either side of the thermal fuse (TF1). Further, because power is drawn through the thermal fuse, use is restricted to only a single thermal fuse.

### SUMMARY OF THE INVENTION

It is, therefore an object of the present invention to provide a relocatable surge protection or surge suppression device for the distribution of electrical power to equipment requiring protection from line disturbances that is safer and provides improved protection, as compared to the state of the art, to the protected devices.

It is a further object of the present invention to provide surge protection or surge suppression that is capable of meeting, if not exceeding, standardized industrial safety tests, such as, but not limited to, Underwriters Laboratories Standard No. 1449.

The foregoing and related objects are accomplished by the present invention, which provides surge suppression or surge protection device affording enhanced safety, as compared to comparable devices known to the state of the art, whereby if any of the metal oxide varistors (“MOVs”) of the surge protectors or surge suppressors fail, the surge suppression or surge protection device will disconnect the protected load rather than just disconnecting the metal oxide varistors (“MOVs”).

Metal oxide varistors (“MOVs”) are known to the skilled artisan to have a significant tendency to overheat and become damaged during certain types of surges. Fuses are placed in series with the MOVs to prevent heat or fire damage to the unit. To meet safety requirements, some fuses cannot be placed in series with the protected load (e.g., a ground or neutral fuse), such that meaning if these types of fuses blow, the load becomes unprotected. In most current surge protectors, a “PROTECTION OK” is provided to warn if the internal fuses have opened. The user is required to routinely inspect the surge protectors to see if they may have failed. A failed surge protector would be providing no meaningful surge protection to the device(s) plugged into it. By using a heater circuit, a thermal fuse(s) is (are) opened when other fuses are open, thereby disconnecting the protected load.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the present invention.

### BRIEF DESCRIPTION OF THE DRAWING FIGURES

In the drawing, wherein similar reference numerals and symbols denote similar features throughout the several views:

Prior Art is a circuit diagram showing method for protecting a load by using a heater and a switching circuit;

FIG. 1 is a circuit diagram showing method for protecting a load by using a heater without a switching circuit;

FIG. 2 is a circuit diagram for protecting a load by using a positive temperature coefficient (PTC) heating element;

FIG. 3 is a circuit diagram showing the heating element of FIG. 2 as being connected to a line in side of a thermal fuse;

FIG. 4 presents a circuit diagram analogous to FIG. 3, but with the switching circuit able to sense when the thermal fuse has been opened;

FIG. 5 shows a circuit diagram that provides a method for allowing a neutral fuse and a line fuse, in series, with the load, that is safe, by having the heating element heating two thermal fuses;

FIG. 6 is a circuit diagram that provides a method within the scope of the present invention that utilizes two heaters with one heater for each of two fuses;

FIG. 7 shows a circuit diagram for an electrical configuration that switches the two heaters of FIG. 6 separately with the switching circuit having a power connection to line in (LI) and neutral in (NI) for opening an opposite fuse relative to the one fuse that is opened;

FIG. 8 is a circuit diagram presenting several possible combinations of fuse configurations that are within the scope of the present invention;

FIG. 9 presents a circuit diagram wherein a neutral fuse is in series with the metal oxide varistor (MOV) and the load, while the switching circuit turns off the heater after the thermal fuse opens;

FIG. 10 is a circuit diagram that presents the circuit configuration of FIG. 8, except that FIG. 8 indicates that there is a similar result achieved when the heater is connected to the line side of the thermal fuse;

FIG. 11 is a circuit diagram showing that the switching circuit turns “on” with the opening of the metal oxide varistor (MOV) only fuse and turns “off” with the opening of the thermal fuse;

FIG. 12 is a circuit diagram showing two thermal fuses connected to one heater, wherein if any fuse opens, the heater will turn “on,” and remain “on,” until the load is completely disconnected from the input;

FIGS. 13 and 14 are circuit diagrams that present the circuit configuration of FIG. 12, except that a minimum load resistor has been replaced by loads that are capable of performing other functions;

FIG. 15 is a circuit diagram that is analogous to the circuit diagram of FIG. 10, except that the heating element (H1) of FIG. 10 has been replaced by two heating elements (H1, H2) for providing one heating element for each of two thermal fuses (TF1, TF2); and,

FIG. 16 is a circuit diagram showing the use of two switching circuits with the two heaters of FIG. 15 turned “off” when both the neutral out and line out are disconnected.

### DETAILED DESCRIPTION OF THE PREFERRED EMBODIMENTS AND DRAWING FIGURES

Turning now, in detail, to an analysis of the accompanying drawing figures, Prior Art presents a circuit diagram demonstrating the prior art concept that the opening of a first fuse can control a switching circuit to turn on a resistor being used as a heater to open a second fuse. More particularly, in the prior art, power is applied between neutral in (Nin) and line in (Lin). During a surge or a metal oxide varistor (40) failure, the fuse (30) opens. When the fuse (30) opens, the switching circuit will connect power to the resistor (R1), thereby heating the resistor (R1) and the thermal fuse (TF1). The thermal fuse (TF) will open when heated and remove power to line out (Lout) and the resistor (R1). This basic method requires the resistor (R1) to be connected to the output of the thermal fuse (TF1) to prevent burning of the resistor.

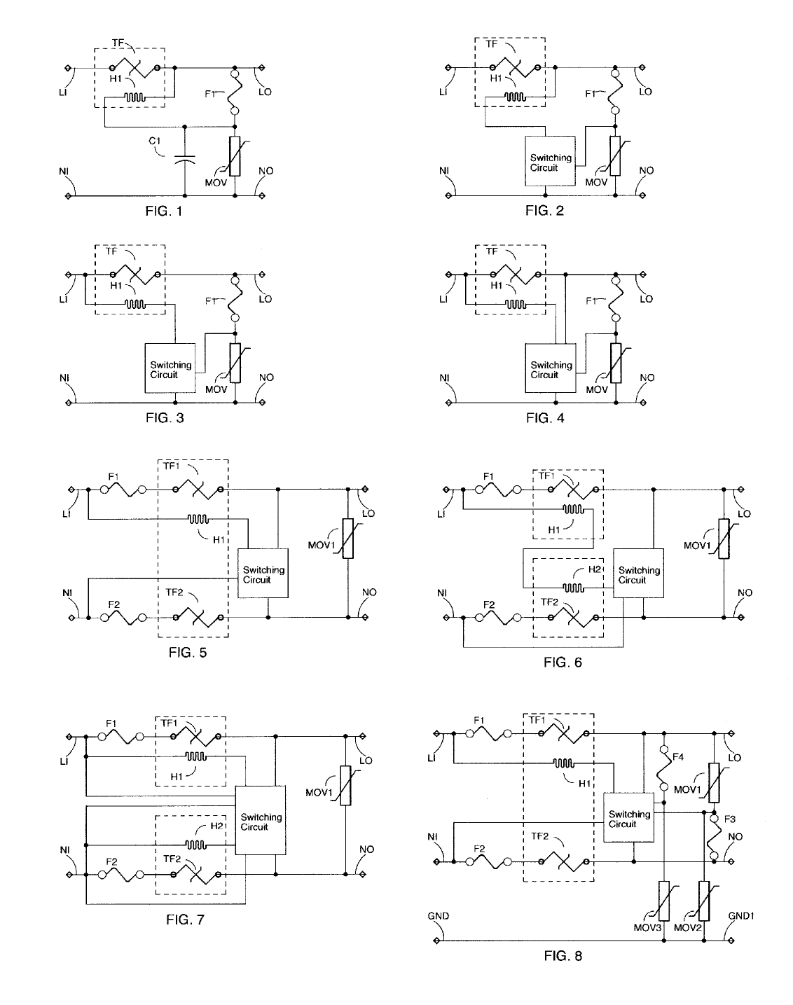

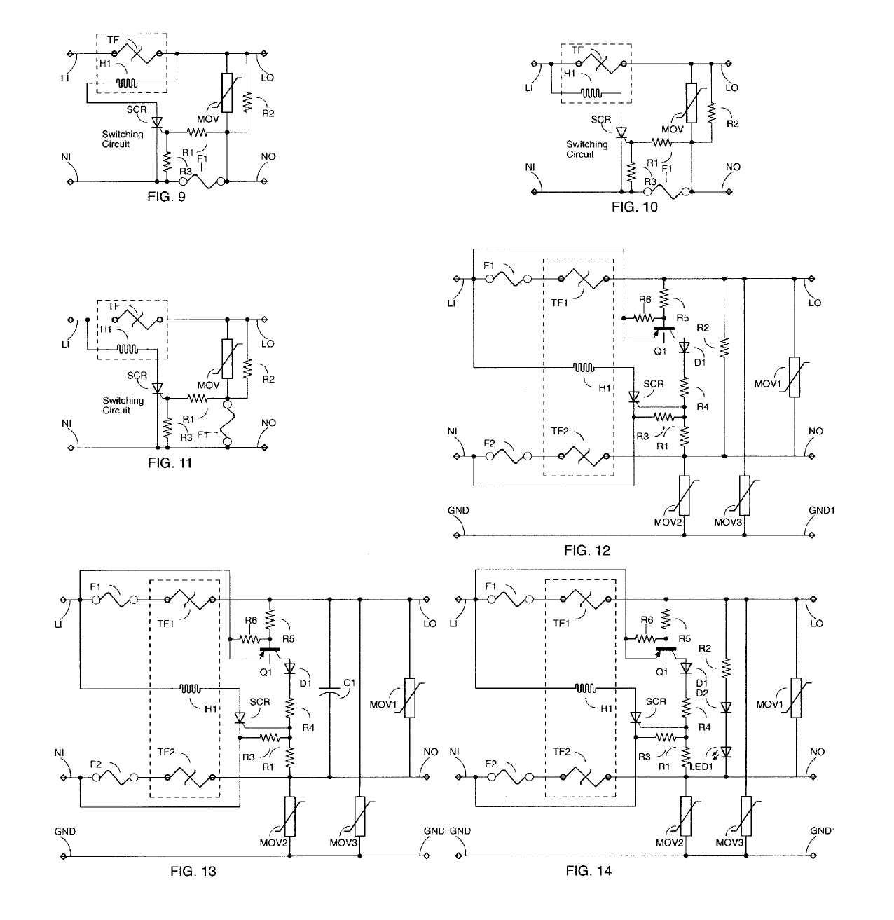

FIG. 1 presents a circuit diagram demonstrating the prior art concept that the opening of a first fuse can control a heater and open a second fuse. More particularly, in FIG. 1, power is applied between neutral in (NI) and line in (LI). During a surge or a failure, the fuse (F1) opens. When the fuse (F1) opens, power will pass though the heating element (H1) and the now-shorted metal oxide varistor (MOV) or the capacitor (C1), thereby heating the heating element (H1) and the thermal fuse (TF). The thermal fuse (TF) will open when heated and remove power between neutral out (NO) and line out (LO). This basic method does not require a switching circuit. A resistor could be used in place of the heating element (H1), but is not recommend. If the metal oxide varistor (MOV) were not to short during a failure, a heating resistor would form a voltage divider with the capacitor (C1) and take longer to open the thermal fuse (TF). A PTC thermistor would rapidly heat to a designated, or pre-determined, temperature over a wide range of input voltages for opening the thermal fuse (TF) more quickly.

FIG. 2 is based on the circuit diagram of the prior art, except that the resistor (R1) has been replaced by the heating element (H1). When the fuse (F1), in series with the metal oxide varistor (MOV) opens, the switch circuit turns “on,” thereby allowing the passing of current through the heating element (H1). The heating element (H1) heats much more quickly than the resistor (R1) utilized in the prior art, removing power quicker from the line out (LO).

FIG. 3 is a circuit diagram showing the heating element of FIG. 2 as being connected to a line in side of a thermal fuse, i.e., the heating element is now connected to line in (LI) instead of line out (LO). This can be done because a heating element can be self-regulating, like a positive temperature coefficient (PTC) heating element. Examples of such heating elements include a PTC thermistor and a light bulb. It should be appreciated that an incandescent light bulb consumes more energy in the form of heat than light.

FIG. 4 presents a circuit diagram analogous to FIG. 3, but with the switching circuit able to sense when the thermal fuse has been opened. More particularly, in FIG. 4, the switching circuit now has an input from the output of the thermal fuse (TF) and line out (LO). In this circuit configuration, the heater (H1) can be turned “off” after the thermal use (TF) has opened. One side of the heater (H1) is connected to line in (LI). Here, a heating resistor could be utilized because of the shut-off feature.

FIG. 5 is a further circuit diagram that evidences the real advantage of FIG. 4: In FIG. 5, the heating element (H1) is in close proximity to two thermal fuses (TF1, TF2). Because the heating element (H1) is connected to line in (LI), the heating element (H1) can still heat the neutral thermal fuse (TF2) after the line thermal fuse (TF1) has opened. The switching circuit can keep the heater on until both thermal fuses (TF1, TF2) have opened. This configuration can remain in a safe condition, even when plugged into a reversed wired outlet, neutral in (NI) and line in (LI) swapped, because both neutral out (NO) and line out (LO) are disconnected. Just as in FIG. 4, a heating resistor can be used, because the switching circuit can remove power after both fuses have opened. As before, if a positive temperature coefficient (PTC) heating element is used, the heating element (H1) could remain on after the fuses have opened.

FIG. 6 is a circuit diagram similar to that of FIG. 5 with the exception that the heating element (H1) of FIG. 5 has been replaced with two heating elements (H1, H2), each near the thermal fuses (TF1 and TF2). By using two heating elements (H1, H2) the thermal fuses (TF1, TF2) may be placed on different parts of the circuit board.

FIG. 7 is a circuit diagram that shows that the switching circuit can control the heating elements (H1, H2) separately. This circuit configuration can be thought of as two switching circuits with a possible interconnection signal, or one switching circuit, where the two heating elements (H1 and H2) are connected in series when the switch is “on.”

FIG. 8 is a further circuit diagram presenting several electrical configurations in which the designations TF are thermal fuses and F are either additional thermal fuses or other types of fuses. The switching circuit in FIG. 8 detects any failure of any fuse and disconnects the load.

FIGS. 9 and 10 present more detailed circuit diagrams: The current fuse (F1) is now between neutral in (NI) and neutral out (NO). Normally, this would be a dangerous circuit configuration and would not pass accepted safety standards. Under normal conditions, the resistor (R2) is the minimum load and passes current from line out (LO) to neutral out (NO). When the fuse (F1) blows, neutral out (NO) would no longer be connected to neutral in (NI) thereby allowing the connected device between neutral out (NO) and line out (LO) to only be connected to line out (LO), thus, allowing the attached device to float to line in (LI) and creating an unsafe condition. However, in this case, current flows through the resistor (R2), through the resistor (R1), and through the gate of the silicon-controlled rectifier (SCR). This turns on the silicon-controlled rectifier (SCR) for allowing current to pass through the heating element (H1), heating the thermal fuse (TF), and opening the connection between line in (LI) and line out (LO). Because the resistor (R2) is connected to the output of the thermal fuse (TF), when the thermal fuse (TF) opens, current though the resistors (R1 and R2) ceases. The silicon-controlled rectifier (SCR) turns off the heater. The difference between FIGS. 9 and 10 is from where the heater draws power, however in this arrangement, there is no difference in the functionality of the circuit. The resistor (R3) is to limit the voltage across the gate of the silicon controlled rectifier (SCR), so that the silicon-controlled rectifier (SCR) is not damaged on the negative cycle. If two resistors (R1 and R2) are sufficiently large, a third resistor (R3) is not needed. Because the voltages on resistors (R1, R2, R3) is alternating, any or all resistors (R1, R2 and R3) could be replaced with capacitors or inductors. The fuse (F1) can be a thermal fuse, any other type of fuse, or a combination of types of fuses.

FIG. 11 presents a similar circuit configuration to that of FIG. 10 with the exception that the neutral fuse (F1) is only in series only with the metal oxide varistor (MOV) and not the load. In this case, when the fuse (F1) opens, the load is now unprotected from line surges. However, just as in FIGS. 9 and 10, the heater (H1) will be turned on until the thermal fuse (TF) opens.

FIG. 12 is a detailed working circuit configuration: In FIG. 12, two thermal fuses (TF1, TF2) protect the load and the metal oxide varistors (MOVs). Further, two current fuses (F1, F2) are in series with the thermal fuses (TF1, TF2). Should either of the neutral fuses fail (F2, TF2), current would pass from line in (LI) though the line fuses (F1 and TF1), through the resistors (R2, R1) and through the gate of the silicon-controlled rectifier (SCR). This would turn on the silicon controlled rectifier (SCR) and the heater (H1), opening the line thermal fuse (TF1) and completely disconnect the protected device. Should either of the line fuses fail (F1, TF1), current would pass though the neutral fuses (F2, TF2), through the resistors (R2 and R5) and through the base of the transistor (Q1) to the emitter and back to the line in (LI). Now current will flow from line in (LI), through the transistor (Q1), through the diode (D1), through the resistor (R4) and through the gate of the silicon-controlled rectifier (SCR). Again, this would turn on the silicon-controlled rectifier (SCR) and the heater (H1), thereby opening the line thermal fuse (TF2) and again completely disconnecting the protected device. After one of the line fuses (F1, TF1) and one of the neutral fuses (F2, TF2), the current path would be as follows: The current would pass from line in (LI) through the resistors (R6, R5, R2, R1, and R3) to neutral in (NI). However, by making the resistors (R1 and R5) with sufficiently large values, and R3 and R6 with relatively small values, so that after a line fuse (F1, TF1) and a neutral fuse (F2, TF2), have opened, not enough voltage is dropped across the resistors (R3, R6) to turn on either silicon-controlled rectifier (SCR) or the transistor (Q1). This turns off the heater (H1) and would allow the heater (H1) to be a resistor. The resistors (R1, R5) should be adequate for preventing any shock hazard to the user, i.e., generally 1 megohm or greater.

FIG. 13 presents a circuit configuration similar to that of FIG. 12, with the exception that the minimum load resistor (R2) has been replaced with a line filter capacitor (C1) that will now serve two functions: a minimum load for the switching circuit (R1, R3-6, Q1, D1 and the SCR) and a line noise filter. This works because the power source is an alternating voltage.

FIG. 14 is a circuit diagram that is substantially similar to that of FIG. 10, except that the minimum load resistor (R2) is also used to feed current to light a light-emitting diode (LED). A reverse protection diode (D2) has also been added to protect the light-emitting diode (LED). Neither of these parts (D2 or LED) will affect the switching circuit because of the polarity in which they are used.

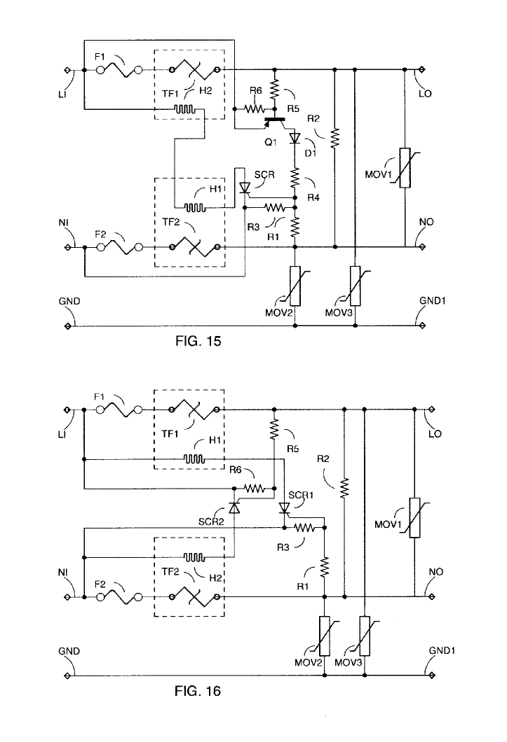

FIG. 15 is also a circuit diagram similar to that of FIG. 10 with the exception that the heating element (H1) of FIG. 10 has been split into two heating elements (H1, H2); one for each of the two thermal fuses (TF1, TF2).

FIG. 16 presents a circuit diagram showing an electrical configuration that uses two switching circuits that are still interconnected though the minimum load resistor (R2). Should one or both of the line fuses (F1 and/or TF1) open, current would flow from neutral in (NI), through the neutral fuses (F2 and TF2), through the resistors (R2 and R5), and through the silicon-controlled rectifier (SCR2) to line in (LI), turning on the silicon-controlled rectifier (SCR2). When the silicon-controlled rectifier (SCR2) turns on, the heating element (H2) will heat up the thermal fuse (TF2) causing thermal fuse (TF2) to open. Likewise, should one or both of the neutral fuses (F2 or/and TF2) open, current would flow from line in (NI), through the line fuses (F1 and TF1), through the resistors (R2 and R1), and through the silicon controlled rectifier (SCR1) to neutral in (NI), turning on the silicon controlled rectifier (SCR1). When the silicon-controlled rectifier (SCR1) turns on, the heating element (H1) will heat up the thermal fuse (TF1), thereby causing thermal fuse (TF1) to open. When two or more fuses, at least one in between line in (LI) and line out (LO), and at least one in between neutral in (NI) and neutral out (NO), the current path is from neutral in (NI), through the resistors (R3, R1, R2, R5, R6) to line in (LI). Similarly, the resistors (R3, R6) have sufficiently low resistance so that the series combined high resistance of resistors (R1, R5) does not supply adequate current to form a voltage greater than 0.6 volts peak across the resistors (R3, R6), not allowing the silicon-controlled rectifiers (SCR1, SCR2) to turn on the heaters (H1, H2).

While only several embodiments of the present invention have been shown and described, it will be obvious to those skilled in the art that many modifications may be made to the present invention without departing from the spirit and scope thereof.

What is claimed is:

1. A relocatable surge suppression or surge protection device, comprising: a plurality of fuses with one fuse of said plurality of fuses being a main thermal fuse; and, a positive temperature coefficient self-regulating heating element in proximity to said main thermal fuse for opening said main thermal fuse when heated.

2. The relocatable surge suppression or surge protection device according to claim 1, further comprising a switching circuit capable of sensing a state of at least one fuse of said plurality of fuses for switching on said positive temperature coefficient self-regulating heating element to said main thermal fuse when an additional fuse of said plurality of fuses has blown.

3. The relocatable surge suppression or surge protection device according to claim 1, wherein said positive temperature coefficient heating element is a positive temperature coefficient (PTC) thermistor or a light bulb.

4. The relocatable surge suppression or surge protection device according to claim 1, wherein said positive temperature coefficient heating element is a light bulb capable of indicating electrical failure.

5. The relocatable surge suppression or surge protection device according to claim 1, further comprising a switching circuit capable of sensing a state of at least one fuse for switching on said positive temperature coefficient heating element to said main thermal fuse when an additional fuse of said plurality of fuses has opened, and for switching off said positive temperature coefficient heating element after said main thermal fuse has opened.

6. The relocatable surge suppression or surge protection device according to claim 1, wherein said plurality of fuses includes a plurality of thermal fuses in combination with more than one said positive temperature coefficient heating element for said plurality of thermal fuses, and further comprising at least one switching circuit for activating at least one said positive temperature coefficient heating element to at least one said thermal fuse when an additional fuse has opened.

7. The relocatable surge suppression or surge protection device according to claim 6, wherein said additional fuse is an additional thermal fuse.

8. The relocatable surge suppression or surge protection device according to claim 6, wherein said at least one switching circuit is capable of switching off at least one said positive temperature coefficient heating element when a predetermined fuse pattern has opened.

9. A surge suppression or surge protection device, comprising:
a plurality of fuses including at least one fuse being a thermal fuse having an input side;
a switching circuit; and,
a heating element in proximity to said thermal fuse for opening said thermal fuse when heated, with a first side of said heating element being connected to said input side of said thermal fuse and a second side of said heating element being controlled via said switching circuit for activating said heating element when said plurality of fuses, other than said thermal fuse, has opened.

10. The surge suppression or surge protection device according to claim 9, wherein said heating element is a resistive wire.

11. The surge suppression or surge protection device according to claim 9, wherein said heating element is a positive temperature coefficient heating element.

12. The surge suppression or surge protection device according to claim 9, wherein said switching circuit is capable of turning off said heating element when a predetermined fuse pattern has opened.

13. The surge suppression or surge protection device according to claim 9, wherein said plurality of fuses includes a plurality of thermal fuses in combination with more than one said heating element for said plurality of thermal fuses connected to said input side of a respective said thermal fuse, with at least one said switching circuit for activating said more than one heating element to said plurality of thermal fuses when an additional fuse has opened.

14. The surge suppression or surge protection device according to claim 13, wherein the said switching circuit switches off the said more than one heating element when a predetermined fuse pattern has opened.

15. A surge suppression or surge protection device, comprising:
a plurality of fuses including a plurality of thermal fuses;
a switching circuit; and,
a heating element in proximity to at least two thermal fuses of said plurality of thermal fuses for opening said at least two thermal fuses, when heated, controlled via said switching circuit that switches on said heating element when any predetermined fuse opens.

16. The surge suppression or surge protection device according to claim 15, wherein said heating element is a resistive wire.

17. The surge suppression or surge protection device according to claim 15, wherein said heating element is a positive temperature coefficient heating element.

18. The surge suppression or surge protection device according to claim 15, wherein said switching circuit is capable of switching off said heating element when a predetermined fuse pattern has opened.

19. The surge suppression or surge protection device according to claim 15, wherein said plurality of thermal fuses is in combination with more than one said heating element, and said switching circuit switches on said more than one said heating element to said plurality of thermal fuses when an additional fuse has opened.

20. The surge suppression or surge protection device according to claim 19, wherein said additional fuse is a thermal fuse.
